(19) United States
(12) Patent Application Publication
(10) Pub. No.: US 2019/0185004 A1
(43) Pub. Date: Jun. 20, 2019

(54) METHOD FOR CONTROLLING DRIVING OF ENVIRONMENTALLY FRIENDLY VEHICLE USING FRONT DRIVING ENVIRONMENT INFORMATION

(71) Applicants: Hyundai Motor Company, Seoul (KR); Kia Motors Corporation, Seoul (KR)

(72) Inventor: Do Hee Kim, Yongin (KR)

(21) Appl. No.: 16/101,484

(22) Filed: Aug. 12, 2018

(30) Foreign Application Priority Data
Dec. 18, 2017 (KR) 10-2017-0174556
Aug. 3, 2018 (KR) 10-2018-0090595

(51) Int. Cl. B60W 30/18; B60L 15/00; B60W 20/00

(52) U.S. Cl. CPC B60W 30/18154; B60L 15/00; B60W 2710/083; B60W 2550/20; B60W 20/00

(57) ABSTRACT

A method for controlling driving of a vehicle using front driving environment information includes: receiving, by a controller, the front driving environment information of the vehicle; predicting, by the controller, occurrence of a control update event for a driving of the vehicle based on the front driving environment information; determining, by the controller, a target speed profile for driving of the vehicle based on the control update event; predicting, by the controller, a control torque of the vehicle corresponding to the target speed profile; and operating, by the controller, a driving device including a driving motor during at least one sampling time interval using the control torque to drive the vehicle.

### CROSS-REFERENCE TO RELATED APPLICATIONS

This application claims under 35 U.S.C. § 119(a) the benefit of Korean Patent Application No. 10-2017-0174556 filed in the Korean Intellectual Property Office on Dec. 18, 2017 and Korean Patent Application No. 10-2018-0090595 filed in the Korean Intellectual Property Office on Aug. 3, 2018, the entire contents of which are incorporated herein by reference.

### BACKGROUND

### (a) Technical Field

The present disclosure relates to a control method for a vehicle, and more particularly, to a method for controlling driving of an environmentally friendly vehicle using front driving environment information.

### (b) Description of the Related Art

An environmentally-friendly vehicle includes a fuel cell vehicle, an electric vehicle, a plug-in electric vehicle, and a hybrid vehicle, and typically includes a motor to generate driving force.

A hybrid vehicle, which is an example of the environmentally-friendly vehicle, uses an internal combustion engine and power of a motor together. In other words, the hybrid vehicle efficiently combines and uses power of the internal combustion engine and power of the motor.

The hybrid vehicle can include an engine, a motor, an engine clutch to adjust power between the engine and the motor, a transmission, a differential gear apparatus, a battery, a starter-generator that starts the engine or generates electricity by output of the engine, and wheels.

Further, the hybrid vehicle can include a hybrid control unit (HCU) for controlling an entire operation of the hybrid vehicle, an engine control unit (ECU) for controlling an operation of the engine, a motor control unit (MCU) for controlling an operation of the motor, a transmission control unit (TCU) for controlling an operation of the transmission, and a battery control unit (BCU) for controlling and managing the battery.

The battery control unit can be referred to as a battery management system (BMS). The starter-generator can be referred to as an integrated starter and generator (ISG) or a hybrid starter and generator (HSG).

The hybrid vehicle can be driven in a driving mode, such as an electric vehicle (EV) mode, which uses only power of the motor, a hybrid electric vehicle (HEV) mode, which uses rotational force of the engine as main power and uses rotational force of the motor as auxiliary power, and a regenerative braking (RB) mode for collecting braking and inertial energy during driving by braking or inertia of the vehicle through electricity generation of the motor to charge the battery.

U.S. Pat. No. 9,070,305, which is in the related art, is directed to a method of calculating position information of a traffic light by detecting information (a position, a direction, a height) of a vehicle and information of the traffic light as an image and a color.

U.S. Pat. No. 7,825,825, which is in the related art, is directed to a method of providing traffic light information to a vehicle.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a method for controlling driving of an environmentally friendly vehicle using front driving environment information which is capable of determining an occurrence of a control update event for a driving of the environmentally friendly vehicle using the front driving environment information (or traffic information) of the vehicle, of predicting a control torque by correcting a control target speed of the vehicle according to the control update event, and of driving the vehicle based on the control torque.

An exemplary embodiment of the present disclosure may provide the method for controlling driving of a vehicle (e.g., an environmentally friendly vehicle) using front driving environment information, including: receiving, by a controller, the front driving environment information of the vehicle; predicting, by the controller, occurrence of a control update event for a driving of the vehicle based on the front driving environment information; determining, by the controller, a target speed profile for driving of the vehicle based on the control update event; predicting, by the controller, a control torque of the vehicle corresponding to the target speed profile; and operating, by the controller, a driving device including a driving motor during at least one sampling time interval using the control torque to drive the vehicle.

The front driving environment information may include static traffic information and dynamic traffic information.

The predicting occurrence of the control update event may include: predicting, by the controller, occurrence of the control update event based on a limit speed change of the vehicle included in the static traffic information, a signal change of a traffic light included in the dynamic traffic information, or a change in traffic situation information included in the dynamic traffic information.

The controller may predict occurrence of the control update event by comparing a previous limit speed of the vehicle included in the static traffic information with a current limit speed of the vehicle included in the static traffic information.

The controller may calculate a speed minimum value and a maximum speed value based on a remaining distance to a traffic light that the vehicle approaches, a red signal remaining time of the traffic light, and a green signal time of the traffic light, and may predict occurrence of the control update event when a current speed of the vehicle is less than the speed minimum value and exceeds the speed maximum value.

The controller may calculate a speed minimum value and a speed maximum value based on a remaining distance to a traffic light that the vehicle approaches, a green signal remaining time of the traffic light, and a red signal time of the traffic light, and may predict occurrence of the control update event when a current speed of the vehicle is less than the speed minimum value and exceeds the speed maximum value.

The controller may calculate a traffic congestion degree of a road including a traffic light that the vehicle approaches based on the number of vehicles in each road section, a distance of the road section, and an average speed of the vehicle in each road section included in the traffic situation information and may predict occurrence of the control update event by comparing a previous traffic congestion degree among the calculated traffic congestion degree with a current traffic congestion degree among the calculated traffic congestion degree.

The determining of the target speed profile may include: determining, by the controller, a control target speed for driving of the vehicle that corresponds to a limit speed of the vehicle, wherein the limit speed of the vehicle is received at the controller when the control update event is generated and is included in the front driving environment information; and determining, by the controller, a deceleration time of the vehicle that is required when the vehicle reaches a position where the limit speed is required and is included in the target speed profile, based on a current speed of the vehicle, the control target speed, and a target acceleration of the vehicle up to the position according to driving propensity of a driver of the vehicle.

The determining of the target speed profile may further include: correcting, by the controller, the target speed profile based on information of a traffic light disposed on a road including the position where the limit speed is required and a congestion degree included in traffic situation information of the road. The information of the traffic light and the traffic situation information may be included in the front driving environment information.

The correcting of the target speed profile may include: correcting, by the controller, the target speed profile based on an access time required for the vehicle to approach the traffic light and a red signal remaining time of the traffic light information. The controller adjusts the control target speed of the target speed profile to zero when the access time is less than or equal to the red signal remaining time.

The correcting of the target speed profile may include: correcting, by the controller, the target speed profile based on an access time required for the vehicle to approach the traffic light, a red signal remaining time of the traffic light information, and the congestion degree. The controller may reduce the control target speed of the target speed profile when the access time exceeds the red signal remaining time and the congestion degree is greater than a reference value.

The predicting of the control torque may include: extracting, by the controller, an acceleration profile based on the target speed profile; and determining, by the controller, a wheel shaft driving torque that is the control torque based on the acceleration profile and a driving load of the vehicle.

The method for controlling driving of the environmentally friendly vehicle using the front driving environment information according to the exemplary embodiment of the present disclosure may improve fuel efficiency or fuel economy of the environmentally friendly vehicle by increasing driving efficiency of the vehicle using the driving (e.g., driving) of the vehicle based on the front driving environment information.

Further, the exemplary embodiment of the present disclosure may determine the occurrence of the control update event for the driving of the environmentally friendly vehicle using the front driving environment information of the vehicle, may predict the control torque by correcting the control target speed of the vehicle according to the control update event, and may drive the vehicle based on the control torque. Therefore, the exemplary embodiment of the present disclosure may be used for an autonomous driving technique of a vehicle.

A non-transitory computer readable medium containing program instructions executed by a processor may include: program instructions that receive front driving environment information of a vehicle; program instructions that predict occurrence of a control update event for a driving of the vehicle based on the front driving environment information; program instructions that determine a target speed profile for driving of the vehicle based on the control update event; program instructions that predict a control torque of the vehicle corresponding to the target speed profile; and program instructions that operate a driving device including a driving motor during at least one sampling time interval using the control torque to drive the vehicle.

### BRIEF DESCRIPTION OF THE DRAWINGS

A brief description of the drawings will be provided to more sufficiently understand the drawings which are used in the detailed description of the present disclosure.

FIG. 1 is a flowchart illustrating a method for controlling driving of an environmentally friendly vehicle using front driving environment information according to an exemplary embodiment of the present disclosure.

FIG. 2 is a block diagram illustrating an environmentally friendly vehicle to which the method according to an exemplary embodiment of the present disclosure is applied.

FIGS. 3 to 5 are views for explaining a step of predicting a control update event shown in FIG. 1.

FIGS. 6 to 8 are views explaining a step of determining a control target speed shown in FIG. 1.

FIG. 9 is a view explaining a step of driving the environmentally friendly vehicle based on a control torque shown in FIG. 1.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In order to sufficiently understand the present disclosure and the object achieved by embodying the present disclosure, the accompanying drawings illustrating exemplary embodiments of the present disclosure and contents described in the accompanying drawings are to be referenced.

Hereinafter, the present disclosure will be described in detail by describing exemplary embodiments of the present disclosure with reference to the accompanying drawings. In describing the present disclosure, well-known configurations or functions will not be described in detail since they may unnecessarily obscure the gist of the present disclosure. Throughout the accompanying drawings, the same reference numerals will be used to denote the same components.

Unless defined otherwise, it is to be understood that the terms used in the present specification including technical and scientific terms have the same meanings as those that are generally understood by those skilled in the art. It must be understood that the terms defined by the dictionary are identical with the meanings within the context of the related art, and they should not be ideally or excessively formally defined unless the context clearly dictates otherwise.

An information and communications technology (ICT) such as a high precision map (or a high precision road map), connectivity, or an internet of things (IoT) has been developed. A technology that uses the ICT to improve fuel efficiency of the vehicle by increasing the vehicle driving efficiency may be required.

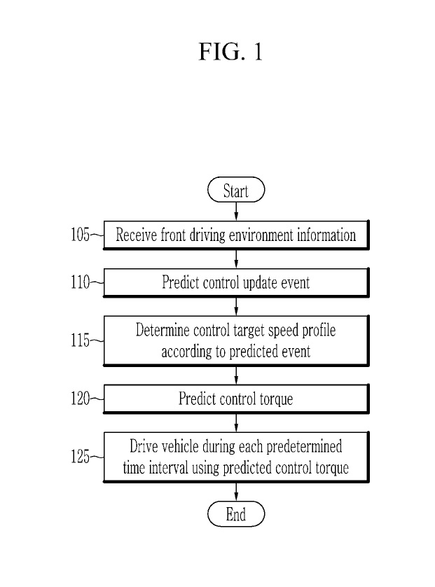

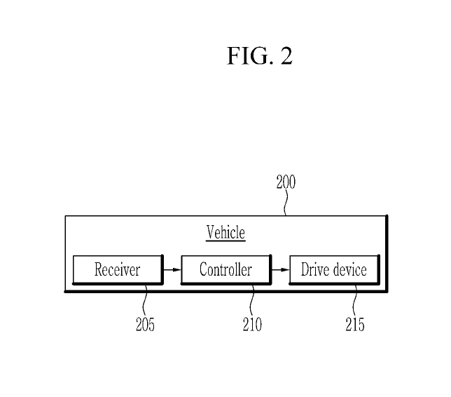

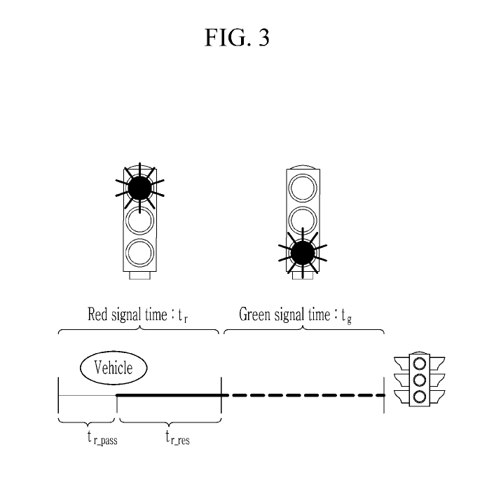

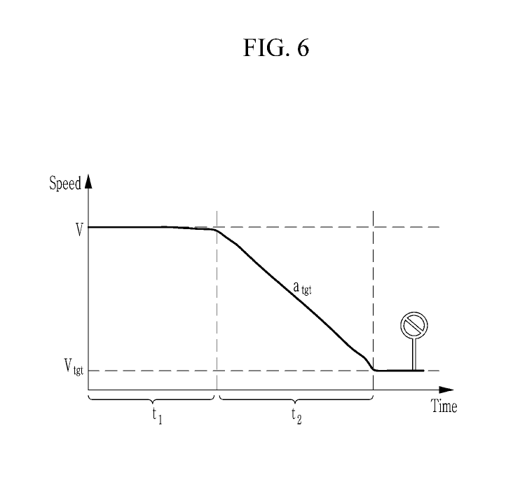

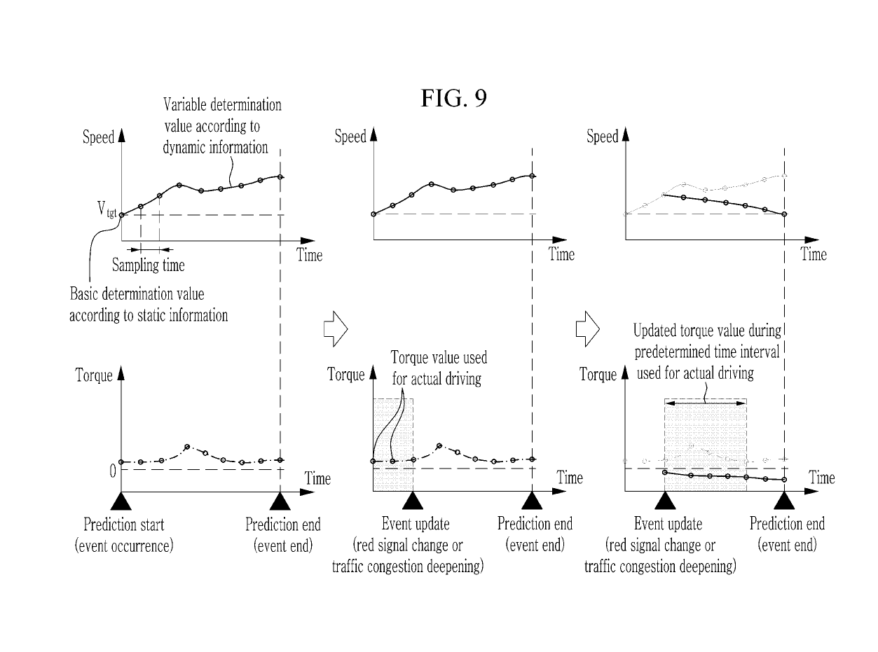

FIG. 1 is a flowchart illustrating a method for controlling driving of an environmentally friendly vehicle using front driving environment information according to an exemplary embodiment of the present disclosure. FIG. 2 is a block diagram illustrating an environmentally friendly vehicle to which the method according to an exemplary embodiment of the present disclosure is applied. FIGS. 3 to 5 are views for explaining a step of predicting a control update event shown in FIG. 1. FIGS. 6 to 8 are views explaining a step of determining a control target speed shown in FIG. 1. FIG. 9 is a view explaining a step of driving the environmentally friendly vehicle based on a control torque shown in FIG. 1.

Referring to FIGS. 1-9, in a reception step 105, a controller 210 included in an environmentally friendly vehicle (or “vehicle”) 200 may receive the front driving environment information of the vehicle through a receiver 205. The front driving environment information may include static traffic information, and dynamic traffic information including traffic light information and traffic situation information.

The static traffic information may be the high precision map including a road gradient, a road curvature, toll gate position, interchange (IC) position, road limit speed, left/right turn information for the vehicle, speed hump position information, or speed camera position information. The traffic light information may include a signal change period, a green signal time, a red signal time, a red signal remaining time, a green signal remaining time, a remaining distance to a traffic light, or position information of the traffic light. The traffic situation information may include the number of vehicles in each road section, a distance of a road section, or an average speed of the vehicle in each road section. Based on the traffic situation information, it may be determined whether a yellow signal time is included in the red signal time or in the green signal time. For example, the yellow signal time may be included in the green signal time when the vehicle traffic flow is determined to be smooth based on the traffic situation information, and the yellow signal time may be included in the red signal time when the vehicle traffic flow is determined not to be smooth based on the traffic situation information. For safety of the vehicle, the yellow signal time may always be included in the red signal time.

The static traffic information may be stored in a navigation device included in the receiver 205. The receiver 205 may include a global positioning system (GPS) receiver that generates position information of the vehicle. The driving environment information may be provided to the controller 210 by a server installed outside the environmentally friendly vehicle 200.

For example, the controller 210 may be one or more microprocessors operated by a program or hardware including the microprocessor. The program may include a series of commands for executing the method for controlling driving of the environmentally friendly vehicle using the front driving environment information according to the exemplary embodiment of the present disclosure. The commands may be stored in a memory.

As shown in FIG. 2, the environmentally friendly vehicle 200 includes the receiver 205, the controller 210, and a drive device 215 including an engine or a driving motor.

According to a prediction step 110, as shown in FIGS. 3 to 5, the controller 210 may determine whether a control update event for a driving of the environmentally friendly vehicle 200 occurs, based on the driving environment information. For example, the driving of the environmentally friendly vehicle 200 may include acceleration driving, deceleration driving, driving, and cruising driving of the vehicle. When the driving of the environmentally friendly vehicle 200 is performed, regenerative braking may be performed.

In the regenerative braking, a battery may be charged by collecting braking or inertial energy during the driving by braking or inertia of the environmentally friendly vehicle 200 using electricity generation of the driving motor. The driving motor may drive a driving wheel of the environmentally friendly vehicle 200. For example, the energy may be collected by the driving in a state where an accelerator pedal and a brake pedal are not pressed when there is a traffic light, a curved road, a vehicle, or an object in front of the environmentally friendly vehicle 200.

The controller 210 may predict the control update event based on a limit speed change of the environmentally friendly vehicle 200 included in the static traffic information or a driving situation change (e.g., a signal change of a traffic light that the environmentally friendly vehicle will approach or a change in traffic situation information) included in the dynamic traffic information. The exemplary embodiment of the present disclosure may predict the control update event using only near information among the traffic information so that a driving route of the environmentally friendly vehicle 200 may not be used for prediction of the control update event.

The controller 210 may predict occurrence of the control update event by comparing a previous limit speed of the environmentally friendly vehicle included in the static traffic information with a current limit speed of the environmentally friendly vehicle included in the static traffic information. For example, when an absolute value of a value obtained by subtracting the current limit speed from the previous limit speed is equal to or greater than a speed reference value, the controller 210 may determine that the control update event occurs.

The controller 210 may calculate a speed minimum value V_{low}_{_}_{bdd} and a maximum speed value Vᵤₚ_{_}_{bdd} of the following equation based on a remaining distance d to a traffic light that the environmentally friendly vehicle 200 will approach, a red signal remaining time tᵣ_{_}ᵣₑₛ of the traffic light, and a green signal time t_{g} of the traffic light.

$${v}_{low \_ bdd} = \frac{d}{{t}_{r \_ res} + {t}_{g}} , {v}_{up \_ bdd} = \frac{d}{{t}_{r \_ res}}$$

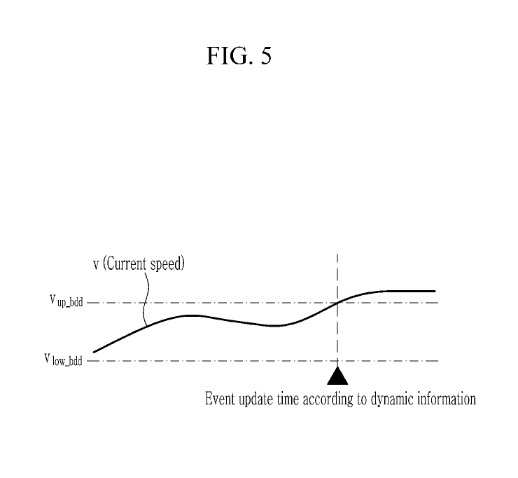

As shown in FIG. 5, when a current speed V of the environmentally friendly vehicle 200 is less than the speed minimum value V_{low}_{_}_{bdd} and exceeds the speed maximum value Vᵤₚ_{_}_{bdd}, the controller 210 may predict occurrence of the control update event. The speed V of the environmentally friendly vehicle 200 can be detected by a speed sensor of the environmentally friendly vehicle and may be provided to the controller 210. The speed sensor may be mounted to the wheel of an environmentally friendly vehicle.

The remaining distance d, the red signal remaining time tᵣ_{_}ᵣₑₛ, the green signal time t_{g}, and a red signal elapsed time tᵣ_{_}ₚₐₛₛ are shown in FIG. 3. FIG. 3 shows a case where the environmentally friendly vehicle 200 approaches the traffic light when a current signal of the traffic light is red.

Based on a remaining distance d to a traffic light that the environmentally friendly vehicle 200 will approach, a green signal remaining time t_{g}_{_}ᵣₑₛ of the traffic light, and a red signal time tᵣ of the traffic light, the controller 210 may calculate a speed minimum value V_{low}_{_}_{bdd} and a speed maximum value Vᵤₚ_{_}_{bdd} of the following equation.

$${v}_{low \_ bdd} = \frac{d}{{t}_{g \_ res} + {t}_{r}} , {v}_{up \_ bdd} = \frac{d}{{t}_{g \_ res}}$$

As shown in FIG. 5, when the current speed V of the environmentally friendly vehicle 200 is less than the speed minimum value V_{low}_{_}_{bdd} and exceeds the speed maximum value Vᵤₚ_{_}_{bdd}, the controller 210 may predict occurrence of the control update event.

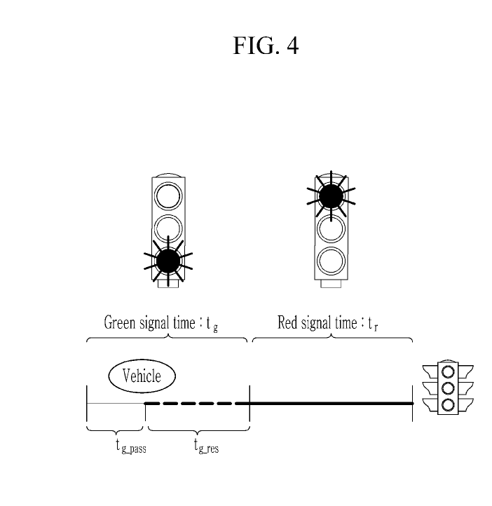

The remaining distance d, the green signal remaining time t_{g}_{_}ᵣₑₛ, the red signal time tᵣ, and a green signal elapsed time t_{g}_{_}ₚₐₛₛ are shown in FIG. 4. FIG. 4 shows a case where the environmentally friendly vehicle 200 approaches the traffic light when a current signal of the traffic light is green.

The controller 210 may calculate a traffic congestion degree of a road including a traffic light that the environmentally friendly vehicle 200 will approach based on the number of vehicles in each road section, the distance of the road section, and the average speed of the vehicle in each road section included in the traffic situation information and may predict occurrence of the control update event by comparing a previous traffic congestion degree among the calculated traffic congestion degree with a current traffic congestion degree among the calculated traffic congestion degree. For example, when an absolute value of a value obtained by subtracting the current traffic congestion degree from the previous traffic congestion degree is equal to or greater than a congestion degree reference value, the controller 210 may determine that the control update event occurs.

According to a determination step 115, the controller 210 may determine a target speed profile for driving (e.g., driving) of the environmentally friendly vehicle 200 based on the control update event. The target speed profile may mean a speed prediction value according to time that is generated until the environmentally friendly vehicle 200 reaches the control target speed. For example, as shown in FIG. 6, the controller 210 may determine the control target speed V_{tgt} for driving of the environmentally friendly vehicle 200 that corresponds to a limit speed of the vehicle. The limit speed of the vehicle may be received at the controller 210 when the control update event is generated and may be included in the driving environment information. The controller 210 may determine a deceleration time t₂ of the environmentally friendly vehicle 200 that is required when the vehicle reaches a position where the limit speed is required and is included in the target speed profile, based on the current speed V of the vehicle, the control target speed, and a target acceleration a_{tgt} of the vehicle up to the position according to driving propensity of a driver of the vehicle.

For example, the deceleration time t₂ may be determined by the following equation.

$${t}_{2} = \frac{V - {V}_{tgt}}{{a}_{tgt}}$$

A magnitude of the target acceleration of the environmentally friendly vehicle 200 may increase when the propensity of the driver is aggressive and may decrease when the propensity of the driver is economical. The target acceleration of the environmentally friendly vehicle 200 according to the driving propensity may be determined by a test and may be stored in the memory of the vehicle to be provided to the controller 210.

In another exemplary embodiment of the present disclosure, the controller 210 may correct the target speed profile based on information of a traffic light disposed on a road including the position where the limit speed is required and the congestion degree included in the traffic situation information of the road.

The controller 210 may correct the target speed profile based on an access time tₐₚₚᵣ required for the environmentally friendly vehicle 200 to approach the traffic light and the red signal remaining time tᵣ_{_}ᵣₑₛ of the traffic light information.

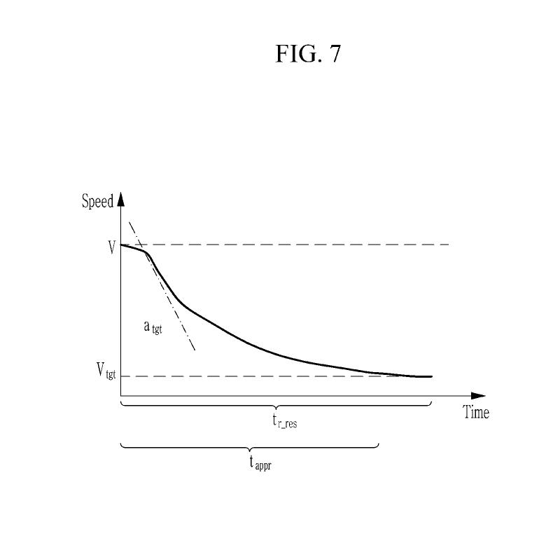

When a current signal of the traffic light is red and the access time tₐₚₚᵣ is less than or equal to the red signal remaining time tᵣ_{_}ᵣₑₛ as shown in FIG. 7, the environmentally friendly vehicle 200 may not pass through the traffic light. Thus, the controller 210 may adjust or control the control target speed V_{tgt} of the target speed profile to zero and may adjust the acceleration a_{tgt} of the target speed profile to a value smaller than zero. The access time tₐₚₚᵣ may be a value obtained by dividing the remaining distance d by a speed of the environmentally friendly vehicle 200.

The controller 210 may correct the target speed profile based on the access time tₐₚₚᵣ required for the environmentally friendly vehicle 200 to approach the traffic light, the red signal remaining time tᵣ_{_}ᵣₑₛ of the traffic light information, and the congestion degree.

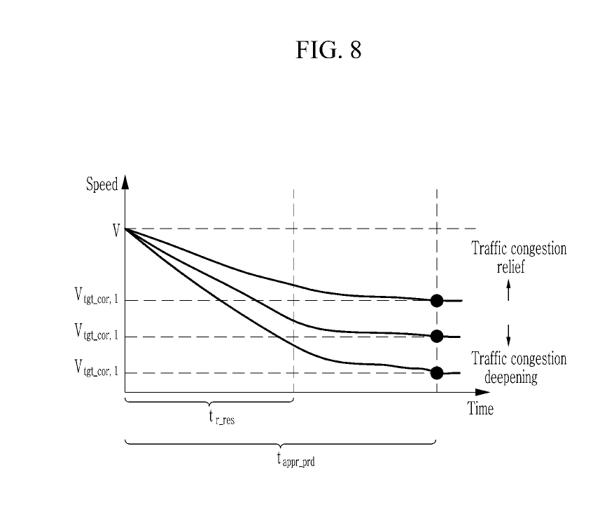

When a current signal of the traffic light is red, the access time tₐₚₚᵣ exceeds the red signal remaining time tᵣ_{_}ᵣₑₛ and the congestion degree is greater than a reference value as shown in FIG. 8, the controller 210 may reduce the control target speed of the target speed profile.

According to a prediction step 120, the controller 210 may predict the control torque of the environmentally friendly vehicle 200 corresponding to the target speed velocity profile. The controller 210 may extract an acceleration profile (e.g., a predicted value of acceleration) a_{prof} based on the target speed profile and may determine a wheel shaft driving torque (e.g., a wheel shaft request torque) T_{whl}_{_}_{dmd} that is the control torque based on the acceleration profile and a driving load F_{R} of the environmentally friendly vehicle 200.

For example, in order to determine the wheel shaft driving torque T_{whl}_{_}_{dmd}, the controller 210 may use the following equation.

$${a}_{prof} = \frac{{F}_{dmd} - {F}_{R}}{m}$$

$${F}_{dmd} = \frac{{T}_{whl \_ dmd}}{{r}_{whl}}$$

$${T}_{whl \_ dmd} = {r}_{whl} ( {ma}_{prof} + {F}_{R} )$$

In the above equation, the m may be a mass (e.g., a weight) of the environmentally friendly vehicle, the r_{whl} may be a wheel radius of the environmentally friendly vehicle, and the F_{dmd} may be a driving force provided to a wheel shaft of the environmentally friendly vehicle.

For example, the controller 210 may calculate the driving load FR using the static traffic information and the following equations according to a longitudinal driving load model of the environmentally friendly vehicle.

The driving load=a load due to air resistance+a load due to rolling resistance+a load due to gradient resistance.

F_{R}=½ρC_{d}AV²+mg(μ·cos θ+sin β)

In the above equation, the ρ may be atmospheric air density (kg/m³), the C_{d} may be an air resistance coefficient and may have a negative sign, the A may be a frontal area of the environmentally friendly vehicle (m²), the V may be a speed of the environmentally friendly vehicle, the m may be weight of the environmentally friendly vehicle, the g may be acceleration of gravity, the μ may be a resistance coefficient, and the β may be an inclination angle or a slope of a road on which the environmentally friendly vehicle travels.

According to a driving step 125, as shown in FIG. 9, the controller 210 may operate the driving device 215 including the driving motor during at least one sampling time interval (or at least one predetermined time interval) using the control torque to drive the environmentally friendly vehicle 200.

The components, “˜ unit”, block, or module which are used in the present exemplary embodiment may be implemented in software such as a task, a class, a subroutine, a process, an object, an execution thread, or a program which is performed in a predetermined region in the memory, or hardware such as a field programmable gate array (FPGA) or an application-specific integrated circuit (ASIC), and may be performed with a combination of the software and the hardware. The components, ‘˜ part’, or the like may be embedded in a computer-readable storage medium, and some part thereof may be dispersedly distributed in a plurality of computers.

As set forth above, exemplary embodiments have been disclosed in the accompanying drawings and the specification. Herein, specific terms have been used, but are just used for the purpose of describing the present disclosure and are not used for qualifying the meaning or limiting the scope of the present disclosure, which is disclosed in the appended claims. Therefore, it will be understood by those skilled in the art that various modifications and equivalent exemplary embodiments are possible from the present disclosure. Accordingly, the actual technical protection scope of the present disclosure must be determined by the spirit of the appended claims.

What is claimed is:

1. A method for controlling driving of a vehicle using front driving environment information, comprising:
receiving, by a controller, the front driving environment information of the vehicle;
predicting, by the controller, occurrence of a control update event for a driving of the vehicle based on the front driving environment information;
determining, by the controller, a target speed profile for driving of the vehicle based on the control update event;
predicting, by the controller, a control torque of the vehicle corresponding to the target speed profile; and
operating, by the controller, a driving device including a driving motor during at least one sampling time interval using the control torque to drive the vehicle.

2. The method of claim 1, wherein the front driving environment information includes static traffic information and dynamic traffic information.

3. The method of claim 2, wherein predicting the occurrence of the control update event comprises:
predicting, by the controller, occurrence of the control update event based on a limit speed change of the vehicle included in the static traffic information, a signal change of a traffic light included in the dynamic traffic information, or a change in traffic situation information included in the dynamic traffic information.

4. The method of claim 3, wherein the controller predicts occurrence of the control update event by comparing a previous limit speed of the vehicle included in the static traffic information with a current limit speed of the vehicle included in the static traffic information.

5. The method of claim 3, wherein the controller calculates a speed minimum value and a maximum speed value based on a remaining distance to a traffic light that the vehicle approaches, a red signal remaining time of the traffic light, and a green signal time of the traffic light, and
wherein the controller predicts occurrence of the control update event when a current speed of the vehicle is less than the speed minimum value and exceeds the speed maximum value.

6. The method of claim 3, wherein the controller calculates a speed minimum value and a speed maximum value based on a remaining distance to a traffic light that the vehicle approaches, a green signal remaining time of the traffic light, and a red signal time of the traffic light, and
wherein the controller predicts occurrence of the control update event when a current speed of the vehicle is less than the speed minimum value and exceeds the speed maximum value.

7. The method of claim 3, wherein the controller calculates a traffic congestion degree of a road including a traffic light that the vehicle approaches based on the number of vehicles in each road section, a distance of the road section, and an average speed of the vehicle in each road section included in the traffic situation information and predicts occurrence of the control update event by comparing a previous traffic congestion degree among the calculated traffic congestion degree with a current traffic congestion degree among the calculated traffic congestion degree.

8. The method of claim 1, wherein determining the target speed profile comprises:
determining, by the controller, a control target speed for driving of the vehicle that corresponds to a limit speed of the vehicle, wherein the limit speed of the vehicle is received at the controller when the control update event is generated and is included in the front driving environment information; and
determining, by the controller, a deceleration time of the vehicle that is required when the vehicle reaches a position where the limit speed is required and is included in the target speed profile, based on a current speed of the vehicle, the control target speed, and a target acceleration of the vehicle up to the position according to driving propensity of a driver of the vehicle.

9. The method of claim 8, wherein determining the target speed profile further comprises:
correcting, by the controller, the target speed profile based on information of a traffic light disposed on a road including the position where the limit speed is required and a congestion degree included in traffic situation information of the road,
wherein the information of the traffic light and the traffic situation information are included in the front driving environment information.

10. The method of claim 9, wherein correcting the target speed profile comprises:
correcting, by the controller, the target speed profile based on an access time required for the vehicle to approach the traffic light and a red signal remaining time of the traffic light information,
wherein the controller adjusts the control target speed of the target speed profile to zero when the access time is less than or equal to the red signal remaining time.

11. The method of claim 9, wherein correcting the target speed profile comprises:
correcting, by the controller, the target speed profile based on an access time required for the vehicle to approach the traffic light, a red signal remaining time of the traffic light information, and the congestion degree,
wherein the controller reduces the control target speed of the target speed profile when the access time exceeds the red signal remaining time and the congestion degree is greater than a reference value.

12. The method of claim 1, wherein predicting the control torque comprises:
extracting, by the controller, an acceleration profile based on the target speed profile; and
determining, by the controller, a wheel shaft driving torque that is the control torque based on the acceleration profile and a driving load of the vehicle.

13. A non-transitory computer readable medium containing program instructions executed by a processor, the computer readable medium comprising:
program instructions that receive front driving environment information of a vehicle;
program instructions that predict occurrence of a control update event for a driving of the vehicle based on the front driving environment information;
program instructions that determine a target speed profile for driving of the vehicle based on the control update event;
program instructions that predict a control torque of the vehicle corresponding to the target speed profile; and
program instructions that operate a driving device including a driving motor during at least one sampling time interval using the control torque to drive the vehicle.
